(19) United States
(12) Patent Application Publication
(10) Pub. No.: US 2013/0256106 A1
(43) Pub. Date: Oct. 3, 2013

(54) BUTTON MECHANISM AND ELECTRONIC DEVICE USING THE SAME

(71) Applicants: XUE-DONG TANG, Shenzhen City (CN); WEI LIU, Shenzhen City (CN)

(72) Inventors: XUE-DONG TANG, Shenzhen City (CN); WEI LIU, Shenzhen City (CN)

(73) Assignees: HON HAI PRECISION INDUSTRY CO., LTD., Tucheng (TW); HONG FU JIN PRECISION INDUSTRY (ShenZhen) CO., LTD, Shenzhen City (CN)

(21) Appl. No.: 13/480,483

(22) Filed: May 25, 2012

(30) Foreign Application Priority Data
Apr. 2, 2012 (CN) 201210095514.0

(51) Int. Cl. H01H 13/76; H01H 21/28

(52) U.S. Cl. 200/5 A; 200/343

(57) ABSTRACT

A button mechanism is arranged in an electronic device for actuating a switch. The button mechanism includes a support fixed in the electronic device, a button, an elastic connection member, and a resisting member. The button includes a button body that can be pressed, and an actuation portion protruding from the button body, the actuation portion being located above the switch. The elastic connection member connects the button body to the support, and the elastic connection member is elastically deformed when the button body is deformed. The resisting member is arranged between the button body and the switch, for preventing the button body from moving down too far, thereby limiting a traveling range of the button body.

### BACKGROUND

1. Technical Field

The present disclosure relates to electronic devices and, particularly to a button mechanism and an electronic device using the button mechanism.

2. Description of Related Art

Many electronic devices, such as televisions and VCD/DVD players, include a number of physical buttons that can be pressed by users to actuate corresponding switches to activate various functions, such as selecting menu items, turning on/off the device, adjusting volume, and the like. However, it is not uncommon for the corresponding switches to break if the corresponding buttons are pressed too hard.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view showing a part of an electronic device arranged with a number of button mechanisms, in accordance with an exemplary embodiment.

FIG. 2 is similar to FIG. 1, but viewed from another viewpoint.

### DETAILED DESCRIPTION

The disclosure is illustrated by way of example and not by way of limitation. It should be noted that references to “an” or “one” embodiment in this disclosure are not necessarily to the same embodiment, and such references mean at least one.

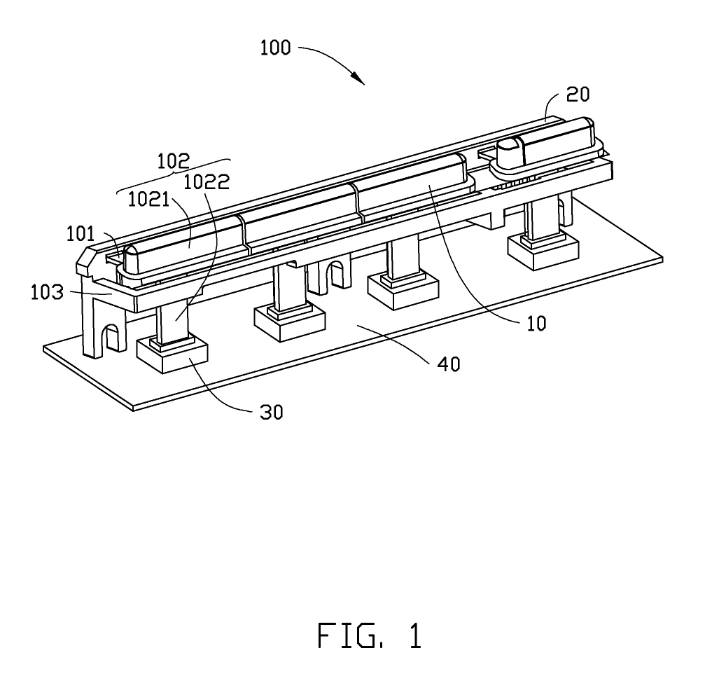

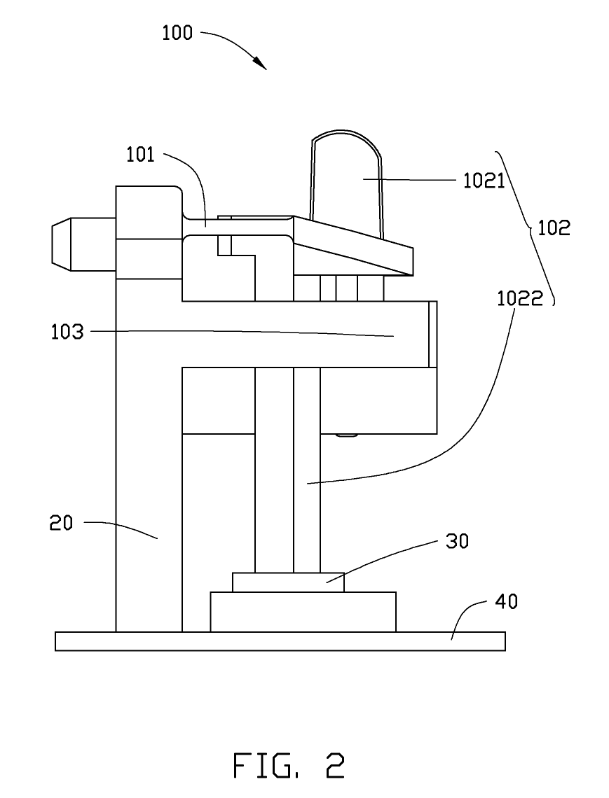

FIGS. 1 and 2 show an electronic device 100 including a main body 40 and at least one button mechanism 10. Each button mechanism 10 is used to receive an external pressure (to be pressed by a user) to actuate a corresponding switch 30 which is fixed to the main body 40. The device 100 may be a television, a VCD/DVD player, or the like. The button mechanism 10 may be a power button or other function selection button. In this embodiment, the electronic device 100 includes four button mechanisms 10.

Each button mechanism 10 includes an elastic connection member 101, a button 102, a resisting member 103, and a support 20. The support 20 is fixed to the main body 40 of the electronic device 100 and near a switch 30 corresponding to the button mechanism 10. In this embodiment, the support 20 has a planar structure which is perpendicular to the main body 40.

The elastic connection member 101 connects the button 102 to the support 20. When the button 102 is depressed, the elastic connection member 101 elastically deforms. When the button 102 is released, the elastic connection member 101 rebounds to its initial position. In this embodiment, the elastic connection member 101 is an elastic tab. Two ends of the elastic tab are respectively perpendicularly connected to the button 102 and the support 20.

The button 102 includes a button body 1021 for being pressed and an actuation portion 1022 protruding from a bottom of the button body 1021. The actuation portion 1022 is located right above the corresponding switch 30 and can move down a limited distance to actuate the switch 30. In this embodiment, the free end of the actuation portion 1022 extends through the resisting member 103 to be suspended upon the switch 30.

The resisting member 103 is arranged between the button body 1021 and the switch 30 and is used to restrict downward movement of the button body 1021, such that the traveling range of the button body 1021 can be limited to a desired range. That is, when moving down a predetermined distance, the button body 1021 (also the actuation portion 1022) will resist against the resisting member 103. Further movement of the button body 1021 (also the actuation portion 1022) is prevented, which protects the switch 30 from being damaged due to overpressure from the actuation portion 1022. In this embodiment, the resisting member 103 perpendicularly protrudes from the support 20, and defines an opening to allow the actuation portion 1022 to extend there through.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A button mechanism arranged in an electronic device for actuating a switch, the button mechanism comprising:
a support fixed in the electronic device;
a button, comprising:
a button body to receive an external press; and
an actuation portion protruding from the button body, the actuation portion being located above the switch;
an elastic connection member connecting the button body to the support, the elastic connection member being elastically deformed when the button body is deformed; and
a resisting member arranged between the button body and the switch, the resisting member being configured to restrict downward movement of the button body, thereby limiting a traveling range of the button body to a desired range.

2. The button mechanism as described in claim 1, wherein when the button body moves down a distance exceeds the desired traveling range, the resisting member resists against the button body.

3. The button mechanism as described in claim 2, wherein the elastic connection member is an elastic tab, and two ends of the elastic tab are respectively perpendicularly connected to the button and the main body.

4. The button mechanism as described in claim 2, wherein a free end of the actuation portion passes through the resisting member to be located above the switch.

5. The button mechanism as described in claim 4, wherein the resisting member perpendicularly protrudes from the main body.

6. An electronic device, comprising:
a main body; and
at least one button mechanism, each button mechanism being for actuating a corresponding switch and comprising:
a support fixed to the main body;
a button, comprising:
a button body to receive an external press; and
an actuation portion protruding from the button body, the actuation portion being located above the switch;
an elastic connection member connecting the button body to the support, the elastic connection member being elastically deformed when the button body is deformed; and
a resisting member arranged between the button body and the corresponding switch, the resisting member being configured to restrict downward movement of button body, thereby limiting a traveling range of the button body to a desired range.

7. The electronic device as described in claim 6, wherein when the button body moves down a distance exceeds to the desired traveling range, the resisting member resists against the button body.

8. The electronic device as described in claim 7, wherein the elastic connection member is an elastic tab, and two ends of the elastic tab are respectively perpendicularly connected to the button and the main body.

9. The electronic device as described in claim 7, wherein a free end of the actuation portion passes through the resisting member to be located above the corresponding switch.

10. The electronic device as described in claim 9, wherein the resisting member perpendicularly protrudes from the main body.
